(19) United States
(12) Patent Application Publication
(10) Pub. No.: US 2016/0322136 A1
(43) Pub. Date: Nov. 3, 2016

(54) METAL-BONDED RE-Fe-B MAGNETS

(71) Applicant: JOZEF STEFAN INSTITUTE, Ljubljana (SI)

(72) Inventors: LUKA KELHAR, Ljubljana (SI); PAUL MCGUINNES, Ljubljana (SI); SPOMENKA KOBE, Ljubljana (SI)

(21) Appl. No.: 14/700,450

(22) Filed: Apr. 30, 2015

(51) Int. Cl. H01F 1/057; H01F 41/02; B22F 3/14

(52) U.S. Cl. CPC H01F 1/0577; B22F 3/14; H01F 41/0266

(57) ABSTRACT

This invention relates to bonded magnets and the method for their production. Such magnets benefit from the fact that for binding, they utilize Low-Melting-Point metal or an alloy, and thus can be used at temperatures where conventional bonded magnets cannot operate. This composite magnet is made of magnetic phase and non-magnetic metallic binder. The mechanical and magnetic properties of metal-bonded magnets vary with the ratio of the two phases. The optimum result is achieved when adding 20-40 wt. % of binder. A huge difference can be observed between conventional and spark-plasma sintering (SPS) processing. An increase in remanence is up to 30%, as a consequence of simultaneous application of pressure and temperature. Additionally, minimized exposure time contributes to preservation of magnetic properties, which is a strong advantage of SPS technique. The value added of such magnets is the ability to withstand temperatures above 200° C., due to metallic matrix.

### FIELD OF THE INVENTION

This invention relates to a novel concept of bonded magnets, more specifically metal-bonded magnets. These composites feature magnetic powder bonded with a low-melting-point (LMP) metal-matrix.

### BACKGROUND OF THE INVENTION

Conventional bonded magnets are usually made of magnetic material and polymer binder and they are popular components for mild conditions where a complex-shape magnet is required. Such a polymer-bonded magnet is described, for example, in EP 2381452 A1. The magnet comprises magnet powder containing a rare-earth element and a resin part binding the magnet powder. Due to poor thermal stability of polymer-bonded magnets, the temperature limit for applications using such magnets is set at max. 180° C., although in most cases it is even lower.

However, with a shift towards the use of these magnets in automotive applications where temperatures easily exceed 100° C., and in many cases higher, and with the additional problem of a corrosive atmosphere, metal-bonded RE-Fe—B magnets (RE: rare earth) become an increasingly attractive option.

Nd—Fe—B is presently the strongest magnetic material. It has a highest energy product of up to 440 kJ/m³ and a Curie temperature of approximately 310° C. One aspect that makes these magnets so attractive is the diversity of their production routes. For Nd—Fe—B, various processing routes can be utilized, depending on the magnetic performance and material cost. Two most commonly used are the sintering process and the rapid solidification process or melt spinning. The former is usually applied when producing fully dense, high-energy magnets and the latter-melt spinning is used for the production of cost-effective polymer-bonded magnets. Enormous magnetic strength of Nd—Fe—B enables miniaturization of products which becomes useful for applications where design greatly depends on the volume of the magnet.

Base material for bonded magnets are crushed melt-spun ribbons, as in EP 1042766 A1, describing the isotropic rare-earth powder material, suitable for the production of bonded magnets. These particles are produced by method of melt-spinning, where molten alloy is ejected from induction-heated crucible onto the cooper cooling wheel, spinning at high circumferential speed. When the melt touches the wheel it solidifies with the cooling rate of up to 10⁶K/s, leaving the melt with almost no time for crystallization. Usually, such rapid quenching results in amorphous microstructure. Later the ribbons are crushed and subjected to appropriate heat treatment, which results in nucleation and growth of nano-grains. In the case of Nd—Fe—B melt-spun ribbons appropriate heat treatment results in microstructure made of nano-sized matrix Nd₂Fe₁₄B grains. This, so-called “2:14:1” phase contributes to the hard-magnetic response of the magnet. Such a nano-structured microstructure is the origin for the good magnetic properties of bonded magnets.

Another type of rapid solidification technique, although not so extensively used on the commercial scale, is atomization. This technique is usually associated with gas or water atomization, although water atomization, vacuum atomization and centrifugal atomization are also available. The process gives spherical powders, suitable for powder metallurgical processing. Commercial spherical powders of magnetic materials are readily available on the market and they are used for the production of bonded magnets. The major benefit is the spherical shape of the particles, which enables higher loading factor, and consequently increased magnetic performance. Additionally, the flowability of spherical powder is superior when compared to melt-spun ribbons, making it attractive for the fabrication of magnets with complex geometry and thin walls. The drawback of this method is lower quench rate, which can lead to an undesired microstructure, but with some adjustments, these obstacles can be solved. U.S. Pat. No. 6,555,018 B2 shows an example for bonded magnets of the RE-Fe—B type made from atomized magnetic powders and for methods of producing the powders and the magnets. The atomized powders are heat treated, combined with a resin or a metallic binder, pressed or moulded, and cured to produce the bonded magnets.

Commercially, Nd—Fe—B powders are usually supplied in already described platelet or spherical geometry, in a size range from 50 to 400 μm, and thickness of 40 μm in case of platelets. In conventional manufacturing, magnetic powders are combined with various compounds in order to produce complex-shaped bonded magnets used for rotors, actuators, sensors etc. The majority of these compounds belong to the group of thermoset, thermoplastic or elastomer binders. Production techniques for magnet manufacturing includes calendaring, compression, extrusion and injection, yielding products that differ in mechanical properties, density and magnetic performance. The advantage of such magnets is the relatively low price, versatile options for production and the ability to fabricate magnets of diverse geometry. However, due to polymer binder these magnets are only suitable for temperatures up to 180° C., which cuts-down many potential applications, demanding higher thermal stability.

S. Ishihara et al., “Consolidation of Fe—Co—Nd—Dy—B Glassy Powders by Spark-Plasma Sintering and Magnetic Properties of the Consolidated Alloys”, Materials Transactions, Vol. 44, No. 1 (2003) pp. 138 to 143, describe the use of Spark-plasma sintering (SPS) at around the glass transition temperature in order to synthesize a hard magnetic bulk material with a nanocomposite structure. The sample is consolidated without bonding materials, the use of which is considered by the authors of this document to be a significant advantage when producing metal-bonded magnets.

### SUMMARY OF THE INVENTION

It is an object of the present invention to provide a new type of bonded magnets, whose working temperature is superior to that of conventional polymer-bonded magnets and which at the same time show a high remanent magnetization and energy product. It is also an object of the invention to provide a method of producing such bonded magnets.

The object is achieved with the bonded magnet and method of claims 1 and 6. Advantageous embodiments of the bonded magnet and of the method are subject of the depending claims or are disclosed in the subsequent portions of the description.

The present invention provides bonded magnets that overcome some of the drawbacks associated with the currently available bonded magnets. In particular, it solves the problem concerning the use of bonded magnets in the temperature range above 200° C., where conventional bonded magnets cannot be used. In commercial bonded magnets the limit is set by deterioration of polymer binder. With the proposed magnets according to the invention this limit is raised by utilizing LMP metals or LMP alloys as the binder, which can have much higher temperature of use. Both phases of the magnet, i.e. the RE-Fe—B phase and the binder phase, result from a hot-compaction process using Spark-Plasma Sintering or Pulsed Electric Current Sintering. Due to this compaction technique the magnet exhibits high remanent magnetization and a high energy product.

The magnetic composite in the present invention consists of magnetic powder, bonded with LMP metal or an alloy. Magnetic material belongs to the RE-Fe—B group, preferably Nd—Fe—B, produced by melt spinning or gas atomization, with nano-sized crystallites and isotropic magnetic characteristic. Composition of the grains corresponds to the Nd₂Fe₁₄B magnetic phase. Possible trace elements include Pr, Co, Zr, Ti, and impurities C, N, O, P and S.

LMP metal/alloy can be Zn, Al, Mg, Cu, Ni, Sn, or Bi metal or combinations of Al—Zn, Mg—Zn, Cu—Zn, Ni—Zn, Bi—Zn, Sn—Zn, Al—Cu, Al—Cu—Si, and Al—Cu—Zn, all with eutectic compositions in order to meet the temperature limitation. More preferably, the LMP phase is Zn or Al—Zn-alloy, with a melting point around 400° C. and good corrosion resistance.

An important parameter is also the size and geometry of the LMP binder, which preferably should be below 50 μm in size and have ribbon-like or spherical morphology. More preferably, it should have spherical particles and a diameter in the range of a few microns. LMP phase should have good flowability to assist in densification of the magnetic composite. The task of this phase is to bond the magnetic particles, therefore sufficient wetting of magnetic and LMP phase must be established.

In this invention we thus present a new type of bonded magnets, whose working temperature is superior to that of conventional polymer-bonded magnets. These newly developed composites use so called “Low-Melting-Point (LMP)” metals and alloys to bind melt-spun magnetic powders. The idea behind metal-bonded magnets is to raise the polymer-set temperature limit above 200° C. in order to use bonded magnets for more demanding applications. An important aspect for selection of the LMP bonding material is a melting point in the range 200-500° C., to prevent unwanted deterioration of hard magnetic phase. Additionally, restrictions such as low cost, eco-sustainability, corrosion resistance and potential for recycling should be taken into account if this magnet was to be used commercially. Another important aspect in the making of metal-matrix composite magnet is appropriate wetting of the magnetic powder and the binder. The wetting angle should be low in order to insure good wetting, and firm bonding of magnetic and LMP phase, thus making a highly dense compact.

All these demands narrow down the potential candidate range to only few metals or alloys indicated above that fit the criteria.

The first step in the fabrication of metal-bonded magnets according to the present invention comprises weighing and mixing of the magnetic and LMP powders in appropriate amounts. The amount of the LMP powder is selected to form between 10 and 50 wt. % of the powder mixture. Next, to ensure an even distribution of binder, the powders must be subjected to a homogenization cycle. This should be done in a closed container for a sufficient amount of time. Preferably, the time of mixing is greater than 5 min. For a thorough mix a combination of rotation, translation and inversion interactions should be implemented to obtain a homogenous distribution of magnetic and binder particles.

The second step incorporates the consolidation of powders using temperature and pressure. It is known that magnetic composites can be consolidated using conventional pressing and sintering but this results are inferior compared to processing with Spark-Plasma Sintering, hot pressing or similar. Since conventional pressing and sintering method uses resistance heating, dissipation of heat is rather slow and this can prolong the manufacturing time. If the composite is exposed to long term processing at high temperatures, this can have a dramatic impact on the magnetic properties of the compact, i.e., magnetic performance is drastically reduced. Our innovative processing route features the use of SPS (Spark-Plasma Sintering)/PECS (Pulsed Electric Current Sintering), a cutting-edge technique in consolidation of advanced materials. In contrast to conventional consolidation, SPS/PECS utilizes short electric pulses to heat the material. Thus, the power is dissipated directly where it is needed, in vicinity of each powder particle inside the compact. This process is known as Joule heating. This way, the temperature can be controlled quickly and accurately since,

Q∝I²*R*t

the amount of heat is proportional to the amount of applied current I, that is by increasing the current the temperature increases exponentially. Simultaneously with heat, we also apply the pressure, which assists in the densification of compact. As opposed to conventional-resistance heating, SPS's fast heating—which can be as high as 1000° C./min—shortens the processing time dramatically, and thus enables the preservation of the initial microstructure, without the unwanted grain-growth phenomenon, which is usually encountered with conventional technique. This fact is especially important for processing of Nd—Fe—B magnetic materials, because significant deterioration of magnetic properties occurs at longer sintering time.

Spark-Plasma Sintering is preferably conducted in the temperature range 350-400° C., depending on the ratio of magnetic/non-magnetic phase in the composite magnet. The mould for SPS is made of graphite or hard-metal, to insure sufficient electrical and thermal conductivity. The system functions by applying DC current through the mould, where powder mixture is heated by dissipation of Joule heat.

### BRIEF DESCRIPTION OF DRAWINGS

In the following the invention is further explained by way of example in connection with the accompanying figures. The figures show:

FIG. 1: Schematics of a Spark-plasma sintering (SPS) machine;

FIG. 2: Hysteresis loops of LMP-bonded (30 wt. % binder) RE-Fe—B powder; and

FIG. 3: Microstructure of LMP-bonded (30 wt. % binder) platelet-like RE-Fe—B powder.

### DETAILED DESCRIPTION OF THE INVENTION

Object of the present invention is fabrication of metal-bonded magnets utilizing magnetically isotropic or anisotropic RE-Fe—B powder and LMP alloy as binding phase. More preferably, it consists of Nd—Fe—B powder blended with Zn powder as in the following example, with melting point of 420° C. Sintering temperature for these compacts is set at 400° C., pressure of 50-500 MPa is applied to assist the densification process. Consolidation time is kept to a minimum, around 5 minutes per cycle to preserve magnetic performance.

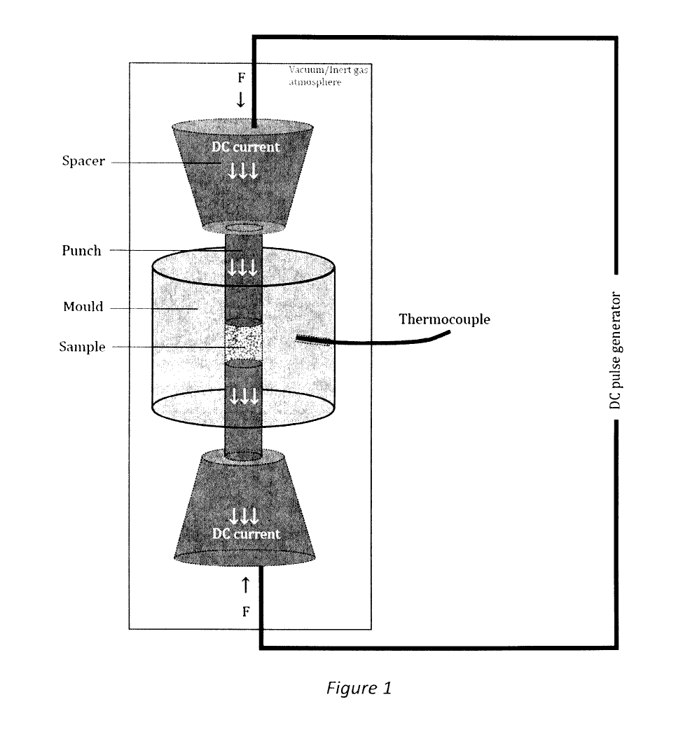

The example features a magnetic powder, made of crushed ribbons in the size range 60-325 μm and LMP particles added in the form of spheres in the size range 1 to 5 μm. The processing route includes mixing of the powders in different amounts and subjecting them to a hot-compaction cycle using a SPS machine. FIG. 1 shows a schematic of such a SPS machine, in which DC-pulses are applied to the powder mixture (sample) arranged in the mould. At the same time the above pressure is applied to the sample by means of the punch.

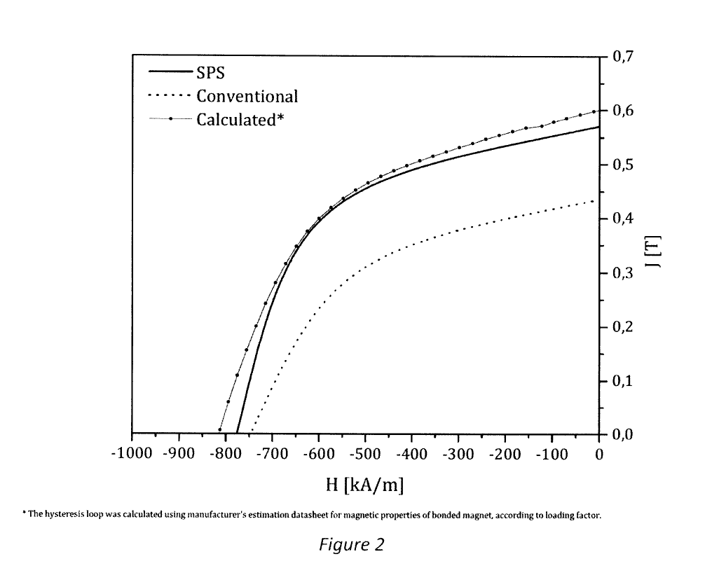

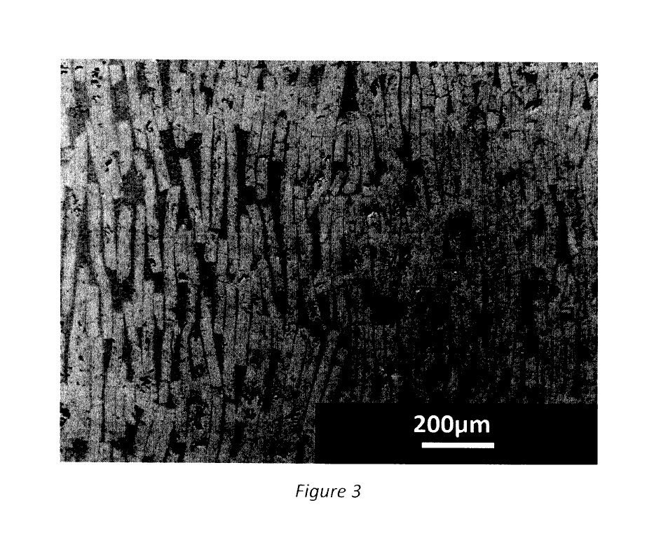

The best results were obtained when adding 20-40 wt. % of binder. When comparing the magnetic properties of conventional processing towards SPS for a composite with 30 wt. % of binder, FIG. 2, a huge difference can be observed. Namely, the remanent magnetization is increased by 30%, the coercivity increase is 3%, and energy product is 70% higher for the SPS processed magnet. The hysteresis loop of SPS-ed sample approaches the calculated loop for a typical bonded magnet. This indicates that the density of composite is close to saturation, which was proven via Archimedes' principle, revealing more than 90% of theoretical density. The corresponding values with conventional route are much lower, due to separate application of pressure and heat and the slow heating rate of conventional resistance heating. This results in longer exposure time at high temperature, which deteriorates the magnetic properties. Microstructure of the composite is shown in FIG. 3. Parallel stacking of the ribbons in the composite contributes to high apparent density. High-pressure SPS consolidation allows for a minimized amount of LMP binder, thus increasing the volume of magnetic powder and maximizing the magnetic performance. Zn bonded Nd—Fe—B composites additionally exhibit good corrosion resistance and greater rigidity, compared to their polymer-bonded counterparts.

1. A bonded magnet at least comprising an isotropic or anisotropic magnetic RE-Fe—B-M phase and a binder phase, wherein:
said RE-Fe—B-M phase originates from a magnetic powder of crushed ribbons or spheres of a RE-Fe—B-M material, RE representing a rare-earth element and M representing an optional trace element,
said binder phase is composed of a Low-Melting Point (LMP) metal or alloy, and
both phases result from a hot-compaction process using Spark-Plasma Sintering or Pulsed Electric Current Sintering.

2. The bonded magnet according to claim 1, wherein RE is Nd and/or M is an element from the group consisting of Co, Ti, Pr and Zr.

3. The bonded magnet according to claim 1, wherein said Low-Melting Point metal or alloy consists of one of Zn, Al, Mg, Cu, Ni, Sn, Bi and a MA-Zn alloy, MA representing one of Al, Mg, Cu, Ni, Sn and Bi.

4. The bonded magnet according to claim 1, wherein the binder phase constitutes 20-40 wt. % of the bonded magnet.

5. The bonded magnet according to claim 1, wherein the magnet resists temperatures above 200° C. without the binder being degraded.

6. A method of producing a bonded magnet, said method at least comprising the steps of:
providing a magnetic powder of platelet-like or spherical particles of a RE-Fe—B-M material, wherein RE represents a rare-earth element and M represents an optional trace element,
providing a binder powder of Low-Melting Point metal or alloy particles,
blending said magnetic powder with said binder powder to form a powder mixture which contains between 10 and 50 wt. % of the binder powder, and
hot-compacting said powder mixture by means of Spark-Plasma Sintering or Pulsed Electric Current Sintering.

7. The method according to claim 6, wherein said hot-compacting is performed at a temperature of 400° C.±50° C. and a pressure of 50-500 MPa.

8. The method according to claim 6, wherein said magnetic powder is mixed with said binder powder in a ratio of 20-40 wt. % binder powder and 80-60 wt. % magnetic powder.

9. The method according to claim 6, wherein the binder powder is provided with a size of the Low-Melting Point metal or alloy particles which is below 50 μm.

10. The method according to claim 6, wherein the binder powder is provided with a spherical or ribbon-like geometry of the Low-Melting Point metal or alloy particles.
